(19) United States
(12) Patent Application Publication
(10) Pub. No.: US 2009/0324966 A1
(43) Pub. Date: Dec. 31, 2009

(54) Multilayer armor plating, and process for producing the plating

(75) Inventors: Bodo Benitsch, Buttenwiesen (DE); Eugen Pfitzmaier, Thierhaupten (DE)

Correspondence Address: LERNER GREENBERG STEMER LLP, P O BOX 2480, HOLLYWOOD, FL, 33022-2480, US

(73) Assignee: SGL Carbon AG

(21) Appl. No.: 10/999,438

(22) Filed: Nov. 29, 2004

(30) Foreign Application Priority Data
Dec. 5, 2003 (EP) 03 027 995.4

(51) Int. Cl. F41H 5/04; B32B 37/00

(52) U.S. Cl. 428/428; 156/275.5; 156/307.3; 428/76; 428/174; 428/162; 428/113; 428/432; 89/36.02; 426/592

(57) ABSTRACT

A multilayer armor plating material contains a single-piece or multi-piece ceramic or metallic layer which, as seen in the direction of attack, is followed by a rear supporting layer of glass fiber-reinforced plastic (GRP) and/or of carbon fiber-reinforced plastic (CRP). As seen in the direction of attack the ceramic or metallic layer is preceded by a front supporting layer of glass fiber-reinforced plastic (GRP) and/or carbon fiber-reinforced plastic (CRP). As a result, the steel or ceramic layer is optimally embedded in a composite between the front and rear supporting layers and thereby supported. This in particular protects the ceramic or steel material from harmful vibrations caused by repeated impact of projectiles, on account of the higher rigidity of the structure reducing the vibration amplitudes.

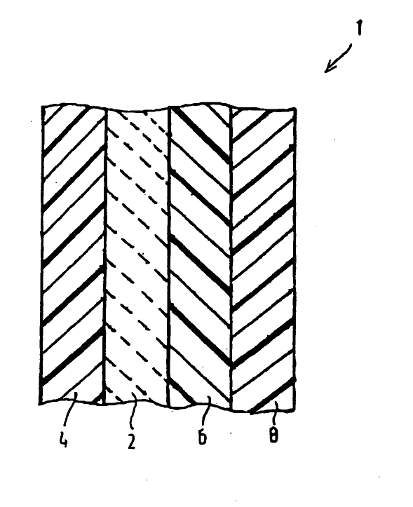

### BACKGROUND OF THE INVENTION

### Field of the Invention

The invention relates to a multilayer armor plating containing a single-piece or multipiece ceramic or metallic layer which, as seen in a direction of attack, is followed by a rear supporting layer formed of a glass fiber-reinforced plastic (GRP) and/or of a carbon fiber-reinforced plastic (CRP).

Armor plating can be used to protect terrestrial and airborne vehicles, such as for example aircraft, helicopters and satellites, as well as potentially endangered people, from impacts and ballistic threats. Armor plating materials with a favorable mass/protection ratio are especially advantageous in the aerospace and aeronautical sector. In the field of civil terrestrial vehicle protection, in particular layers based on special steel grades are in use for destroying projectiles, whereas ceramic layers are used in the military sector and also to protect people.

Armor plating based on ceramics has a lower weight per unit area for the same protective power compared to steel solutions. On the other hand, steel has a better multi-hit behavior. This is to be understood as meaning the retention of projectile-arresting properties in the event of multiple impacts received and the impacts being spaced at short distances apart. In the case of armor plating formed of a steel layer, the distances are typically in the range of distances corresponding to three times the diameter of projectiles. If a ceramic layer is used, the distance that can be tolerated is approximately in the range of eight to 10 times the diameter of the projectile.

A common feature of all the solutions in which the projectile or projectile core must first be broken is that they contain at least two layers with different functions. A front layer, which faces the load resulting from the attack and contains, for example, steel or ceramic, and serves the purpose of as far as possible fragmenting the projectile. A further layer, known as the backing, is responsible for trapping projectile splinters and absorbing the remaining kinetic energy. The layers can be in direct contact with one another and are adhesively bonded to one another or are at a defined distance from one another in a partitioned system.

Published, Non-Prosecuted German Patent Application DE 41 14 809 A1, which forms the generic prior art, describes a projectile-resistant plate material having a front layer composed of hexagonal ceramic plates, which is followed, as seen in the direction of attack, by a first, hard laminate layer of compacted GRP material. With the insertion of an adhesive film, a second laminate layer of GRP material is provided, this layer being softer than the first laminate layer. The rear, hard laminate layer, which acts as a supporting layer, is intended to support the ceramic layer when the latter is pierced by a projectile or by projectile splinters formed on impact. The following, softer laminate layer is intended, as a trapping layer, to trap the projectile or projectile splinters without tearing.

Published, European Patent EP 1 288 607 A1 discloses a multilayer armor plating material containing a monolithic ceramic layer, an antiballistic backing material secured to the ceramic layer and an outer sheath made of an antiballistic material surrounding the backing layer and the ceramic layer and containing a curable resin. The outer sheath, which completely surrounds the composite structure of ceramic and backing, serves to enclose the ceramic antiballistic material that has been joined to a backing in a compressed state. This sheath allows the ceramic/backing composite to withstand even multi-hit attacks. The outer sheath, like the backing, contains an antiballistic material. Suitable materials include fibers with an antiballistic quality, i.e. a high elasticity, elastic deformability and a relatively high modulus, e.g. aramid, Zylon® or special glass fibers impregnated with a suitable quantity of resin.

For weight-optimized approaches, the solutions are often based on a combination of a ceramic layer and a fabric-based backing, for example of aramid or dyneema. However, the minimum possible distance between impact points from projectiles fired for systems of this type is higher than that which is desired and higher than that which can be realized with steel. The reasons for this are first the limited shear strength of the adhesive between ceramic and the fabric and second the damage to the ceramic, and the associated decrease in the rigidity of the overall system, in the event of repeated impact of projectiles. Furthermore, even if steel layers are used, the rigidity is often no longer sufficient when struck by projectiles with a high kinetic energy and a high hardness.

### SUMMARY OF THE INVENTION

It is accordingly an object of the invention to provide a multilayer armor plating, and a process for producing the plating that overcome the above-mentioned disadvantages of the prior art devices and methods of this general type, which has a higher protective power at the lowest possible weight, in particular when exposed to multi-hit attacks.

With the foregoing and other objects in view there is provided, in accordance with the invention, a multilayer armor plating. The armor plating contains a layer being formed of a single-piece ceramic layer, a multi-piece ceramic layer, a single-piece metallic layer, or a multi-piece metallic layer. The layer has a first side facing a direction of attack and a second side. A rear supporting layer formed of glass fiber-reinforced plastic and/or carbon fiber-reinforced plastic is disposed next to the second side of the layer. A front supporting layer formed of glass fiber-reinforced plastic and/or carbon fiber-reinforced plastic is disposed on the first side of the layer.

On account of the fact that, as seen in the direction of attack, the ceramic or metallic layer is preceded by a front supporting layer of glass fiber-reinforced plastic (GRP) and/or carbon fiber-reinforced plastic (CRP), the steel or ceramic layer is optimally embedded in a composite between the front and rear supporting layers and thereby supported. This in particular protects the ceramic or steel material from harmful vibrations caused by repeated impact of projectiles, on account of the higher rigidity of the structure reducing the vibration amplitudes. One particular advantage of the supporting layers formed of glass fiber-reinforced plastic (GRP) and/or carbon fiber-reinforced plastic (CRP), moreover, is their ability to adapt to curved or angled surfaces, so that the armor plate material according to the invention can be used universally to protect surfaces of any desired shape.

The front supporting layer of glass fiber-reinforced plastic and/or carbon fiber-reinforced plastic is applied to the surface of the ceramic or metallic layer which faces the load resulting from the attack and/or the rear supporting layer of glass fiber-reinforced plastic and/or carbon fiber-reinforced plastic is applied to that surface of the ceramic or metallic layer which faces away from the load resulting from the attack. The front and rear supporting layers are formed from woven glass fiber fabrics and/or woven carbon fiber fabrics being impregnated with a binder, in particular with a binder resin in order to form fiber mats (prepregs or wet laminates) impregnated with the binder, and the impregnated prepegs or wet laminates are cured by heat and/or by electromagnetic radiation during a curing period and are pressed onto one or both surfaces of the ceramic or metallic layer at least during part of the curing period. This results in a hot-pressing process in which the curing binder of the fiber mats disposed on both sides is responsible for cohesive bonding to the surface of the ceramic or steel layer without an adhesive additionally having to be used. Moreover, the pressure from both sides advantageously allows both supporting layers, namely the front and the rear supporting layer, to be applied to the ceramic or steel layer during a single process step.

According to a preferred embodiment, the ceramic or metallic layer is completely enclosed by the front supporting layer and the rear supporting layer, in particular at the end faces. This advantageously produces a particularly rigid and strong cohesion to the composite.

It is also advantageous to use glass-fiber reinforced plastic and/or carbon fiber-reinforced plastic for the front and/or rear supporting layer if the ceramic or metallic layer at least locally deviates from a flat plate and has a curvature and/or an angled-off section and/or if the layer thickness of the ceramic or metallic layer is variable, since most fiber plastics, which are based on non-crimp fabrics, woven fabrics, formed-loop knitted fabrics or drawn-loop knitted fabrics, can easily be matched to uneven shapes prior to curing. It is particularly preferable for the glass fiber-reinforced plastic and/or the carbon fiber-reinforced plastic to contain a unidirectional non-crimp fabric containing layers of parallel fibers disposed offset by 90° with respect to one another.

According to a refinement the front supporting layer and/or the rear supporting layer has a carbon and/or glass fiber content of at least 10% by volume.

According to a further measure, the matrix of the front supporting layer and/or of the rear supporting layer contains a polymer which can be cured by heat and/or by electromagnetic radiation, for example of a phenolic resin.

If a ceramic layer is used, the latter may include a monolithic ceramic, for example of aluminum oxide or silicon carbide. Alternatively, it is also possible to use a fiber-reinforced ceramic. In particular, a ceramic that is sintered or produced by infiltration with liquid silicon is used.

Fiber-reinforced ceramics may preferably be what are known as C/SiC materials in which preferably carbon-based fibers, in particular carbon fibers or graphite fibers are bound in a matrix formed predominantly from SiC, Si and C. The C/SiC composite ceramics may also contain other fibers that are able to withstand high temperatures and in addition to carbon also contain further elements such as for example Si, B, N, O or Ti. The procedure used to produce C/SiC material is characterized in that first of all a CFC material is produced. It is particularly preferable to produce CRP (carbon fiber-reinforced plastics) reinforced by bundles of short fibers and formed of carbon fibers or fiber bundles coated with a carbonizable substance and/or with carbon, as well as fillers and binders, which is pressed with a core to produce the desired shape and cured and is then carbonized and/or graphitized, so that a CFC or C/C shaped body is formed as an intermediate product. In the present case, the shaped body is produced as a thin plate of the desired thickness. The base material is meanwhile not restricted to CFC materials. The fiber material used may also be further thermally stable ceramic fibers, in particular based on SiO₂, Al₂O₃, ZrO₂ or SiC, which have been coated with carbon or graphite.

The plate material of carbon fiber-reinforced carbon material is then infiltrated, at temperatures around 1600° C. in vacuo or under inert gas, with a silicon melt or a silicon alloy melt, with the result that at least some of the carbon of the matrix and/or the fibers is converted into SiC. In addition to silicon, the metals of transition groups I to VIII may also be used as further constituents of the melt, in particular Ti, Cr, Fe, Mo, B and Ni. The liquid infiltration of the CFC shaped body produces a dense, strong and very hard shaped body of C/SiC material containing fibers, generally carbon fibers, with a matrix predominantly comprising SiC, Si and C.

Alternatively, the matrix of the shaped body may be produced completely or partially by vapor phase infiltration (CVD or CVI). Then, the matrix has a relatively high SiC content, typically over 95%. Furthermore, the matrix can be produced by pyrolysis of Si-containing, pre-ceramic polymers, such as for example by the pyrolysis of polymers which contain one or more the elements Si, B, C, N, P or Ti.

Preferred applications for the armor plating material according to the invention relate to ballistics protection in land vehicles, aircraft and vessels, as an inlay or integral part of bullet-proof vests, and as a shield protecting satellites. In all these applications, in particular the low weight of glass fiber-reinforced plastic or carbon fiber-reinforced plastic is advantageous. For the latter application, as a shield protecting satellites, in particular a ceramic based on C/SiC material is advantageous on account of the high thermal stability.

According to a particularly preferred refinement of the invention, a trapping layer, which in particular contains aluminum, aramid or dyneema, is simultaneously applied by the pressing operation and the curing, to that surface of the rear supporting layer which faces away from the load resulting from the attack. It is then possible for four layers, namely the front supporting layer, the ceramic or steel layer, the rear supporting layer and the trapping layer to be joined to one another by a single pressing operation, with the cohesive bonding between the individual layers in each case being brought about by the curing binder of the prepregs forming the front and rear supporting layers.

Alternatively, it is possible for some or all of the above-mentioned layers also to be adhesively bonded to one another by means of liquid adhesives or adhesive films.

Other features which are considered as characteristic for the invention are set forth in the appended claims.

Although the invention is illustrated and described herein as embodied in a multilayer armor plating, and a process for producing the plating, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The single FIGURE of the drawing is a diagrammatic, sectional view through armor plating in accordance with a preferred embodiment of the invention.

### DESCRIPTION OF THE PREFERRED EMBODIMENTS

Referring now to the single FIGURE of the drawing in detail, there is shown in the context of a production process, the preferred exemplary embodiment of armor plating 1. The armor plating is formed of an approximately 12 mm thick ceramic plate 2 reinforced with carbon fibers, in particular a plate of a C/SiC composite ceramic with dimensions of 350 mm×400 mm. The plate is directly covered, on a surface facing away from the impact or energy absorption side resulting from an attack, with 12 individual layers of a unidirectional non-crimp fabric containing layers of parallel carbon fibers disposed offset by 90° with respect to one another. Two individual layers of preferably the same unidirectional non-crimp fabric are brought directly to bear against the opposite surface, facing the load resulting from the attack, of the ceramic plate.

Before or at the same time as they are applied to the ceramic layer 2, both non-crimp fabrics are impregnated with a polymer which can be cured by heat and/or by electromagnetic radiation, in particular with a phenolic resin, as binder, in order to form fiber mats impregnated with the binder, known as prepregs, in which the matrix is formed of the polymer.

The curing of the prepregs to form carbon fiber-reinforced plastic (CRP) is preferably carried out by a standard autoclaving process in which the impregnated prepregs surrounding the ceramic layer 2 are cured, for example at a curing temperature in a range between 50° C. and 180° C., while at the same time being pressed onto the ceramic layer. During the curing operation, adhesion or cohesion of the prepregs to the surfaces of the ceramic layer 2 occurs as a result of the initially still viscous binder penetrating into the rough surface structure of the ceramic layer, where it solidifies or cures after a certain time. In this case, the cured prepreg disposed in front of the ceramic layer, as seen in the direction of attack, forms a front supporting layer 4, and the cured prepreg disposed behind the ceramic layer 2, as seen in the direction of attack, forms a rear supporting layer 6. During the production process, the ceramic layer may particularly preferably be completely encased by the front supporting layer and the rear supporting layer, in particular at the end faces.

As part of the pressing and curing operation, it is preferable for a trapping layer 8, which in particular includes aluminum, aramid or dyneema and has a thickness of approximately 10 mm, is simultaneously applied to that surface of the rear supporting layer which faces away from the load resulting from attack. It is then possible for four layers, namely the front supporting layer 4, the ceramic or steel layer 2, the rear supporting layer 6 and the trapping layer 8 to be joined to one another by a single pressing operation.

Alternatively, the pressing and curing operation is restricted to the front supporting layer 4, the ceramic layer 2 and the rear supporting layer 6. The trapping layer 8 in the form of an approximately 10 mm thick backing of woven aramid fabric may also be adhesively bonded to the layer body which has been prepared in this manner.

On account of the flexible materials properties of the prepregs prior to curing, the front supporting layer 4 and/or the rear supporting layer 6 and if appropriate also the backing 8 may be applied not to a planar ceramic layer 2, but to a ceramic layer 2 which at least locally deviates from a flat plate and has a curvature and/or an angled-off section and/or varies in terms of layer thickness.

The armor plating material had a weight per unit area of less than 45 kg/m² and was tested to bullet proof class FB 7 in attack tests. The results revealed a significant increase in the strength compared to armor plating without a front, glass or carbon fiber-reinforced supporting layer 4. The primary damage, but in particular the secondary damage, to the ceramic plate resulting from the impact of the projectile was greatly reduced. In the embodiment with adhesively bonded backing 8, it was possible to reduce the loads on the adhesive bond between the rear supporting layer 6 and the backing 8 to such an extent that the partial or complete detachment of the backing 8 which is otherwise observed remained absent, with the result that the armor plating 1 remained intact even in the event of a multi-hit attack and the multi-hit properties were greatly improved. Overall, the above-mentioned measures increased not only the protection provided on a weight per unit area basis, but also allowed the bonding of the backing 8 to the remainder of the ballistic system to be significantly improved.

In the further embodiments, in each case only the features of the armor plating that are specifically described below are altered, while otherwise the structure was kept the same as in the preferred exemplary embodiment.

For example, the carbon fiber-reinforced ceramic plate 2 of the preferred embodiment was replaced by a plate of monolithic ceramic formed, for example, of aluminum oxide. The dimensions of the ceramic were approximately 250 mm×350 mm, and the thickness was 8 mm.

According to a refinement of the embodiment described initially, the carbon fiber-reinforced ceramic plate 2 was replaced with a plate of ballistic steel with a thickness of approximately 8 mm.

According to a refinement, the ceramic layer 2 of the armor plating 1 was constructed from individual ceramic tiles with dimensions of 20 mm×20 mm×8 mm and were placed against one another in the manner known for ballistic systems in order to form a ceramic structure with dimensions of 300 mm×300 mm.

In a further embodiment, the ceramic layer 2 was curved, with its geometry in particular matching the wheel housing of a motor vehicle, it being possible for the front and rear supporting layers 4, 6, which contain flexible fiber non-crimp fabrics, to be easily matched to the curved shape prior to curing.

Furthermore, curved armor plating material 1 based on a ceramic layer 2 was also produced as an inlay for a bullet proof or armored vest. The overall protection system as a combination of inlay and vest liner was tested as described in the introduction, with correspondingly positive results.

According to a further refinement, a dyneema non-crimp fabric was inserted as the backing 8. It is also conceivable to use a front and/or rear supporting layer 4, 6 composed of a hybrid woven fabric made up of carbon and aramid fibers or carbon and glass fibers.

This application claims the priority, under 35 U.S.C. § 119, of European patent application No. 03 027 995.4, filed Dec. 5, 2003; the entire disclosure of the prior application is herewith incorporated by reference.

1. A multilayer armor plating, consisting of:
a layer selected from the group consisting of a single-piece ceramic layer, a multi-piece ceramic layer, a single-piece metallic layer, and a multi-piece metallic layer, said layer having a first side facing a direction of attack and a second side;
a rear supporting layer formed of at least one of glass fiber-reinforced plastic and carbon fiber-reinforced plastic disposed next to said second side of said layer; and
a front supporting layer formed of at least one of glass fiber-reinforced plastic and carbon fiber-reinforced plastic disposed on said first side of said layer;
said at least one of glass fiber-reinforced plastic and carbon fiber-reinforced plastic forming said rear supporting layer and said front supporting layer being in a cured, non-flexible state.

2. The armor plating according to claim 1, wherein said layer has end faces and is completely encased by said front supporting layer and said rear supporting layer, including at said end faces.

3. The armor plating according to claim 1, wherein said layer at least locally deviates from a flat plate and has at least one of a curvature and an angled-off section.

4. The armor plating according to claim 1, wherein said layer has a thickness that is variable.

5. The armor plating according to claim 1, wherein said front supporting layer and/or said rear supporting layer has a carbon fiber and/or glass fiber content of at least 10% by volume.

6. The armor plating according to claim 5, wherein said carbon fibers and said glass fibers are in a form selected from the group consisting of non-crimp fabrics, woven fabrics, formed-loop knitted fabrics and drawn-loop knitted fabrics.

7. The armor plating according to claim 6, wherein said glass fiber-reinforced plastic and/or the carbon fiber-reinforced plastic is formed of a unidirectional non-crimp fabric composed of layers of parallel fibers disposed offset by 90° with respect to one another.

8. The armor plating according to claim 1, wherein said front supporting layer and/or said rear supporting layer has a matrix formed of a polymer which is cured by heat and/or by electromagnetic radiation.

9. A multilayer armor plating, comprising:
a fiber-reinforced ceramic layer including at least one of carbon fibers or graphite fibers bound in a matrix formed predominantly of SiC, Si and C, said fiber-reinforced ceramic layer having a first side facing a direction of attack and a second side;
a rear supporting layer formed of at least one of glass fiber-reinforced plastic and carbon fiber-reinforced plastic disposed next to said second side of said fiber-reinforced ceramic layer;
a front supporting layer formed of at least one of glass fiber-reinforced plastic and carbon fiber-reinforced plastic disposed on said first side of said fiber-reinforced ceramic layer; and
a trapping layer containing a material selected from the group consisting of aluminum, aramid and dyneema, said trapping layer, as seen in the direction of attack, following said rear supporting layer and having no direct contact with said fiber-reinforced ceramic layer.

10. The armor plating according to claim 1, wherein said layer includes a material selected from the group consisting of a monolithic ceramic, a fiber-reinforced ceramic, a sintered ceramic and a ceramic which has been produced by infiltration with liquid silicon.

11. An armored vehicle, consisting of:
a vehicle selected form the group consisting of land vehicles, aircraft; and vessels;
a ballistic armor protection disposed on said vehicle, said ballistic armor protection, including:
a layer selected from the group consisting of a single-piece ceramic layer, a multi-piece ceramic layer, a single-piece metallic layer, and a multi-piece metallic layer, said layer having a first side facing a direction of attack and a second side;
a rear supporting layer formed of at least one of glass fiber-reinforced plastic and carbon fiber-reinforced plastic disposed next to said second side of said first layer; and
a front supporting layer formed of at least one of glass fiber-reinforced plastic and carbon fiber-reinforced plastic disposed on said first side of said layer;
said at least one of glass fiber-reinforced plastic and carbon fiber-reinforced plastic forming said rear supporting layer and said front supporting layer being in a cured, non-flexible state.

12. A bullet proof vest, consisting of:
a vest containing a multilayer armor plating, the multilayer armor plating containing:
a layer selected from the group consisting of a single-piece ceramic layer, a multi-piece ceramic layer, a single piece metallic layer and a multi-piece metallic layer, said layer having a first side facing a direction of attack and a second side;
a rear supporting layer formed of at least one of glass fiber-reinforced plastic and carbon fiber-reinforced plastic disposed next to said second side of said first layer; and
a front supporting layer formed of at least one of glass fiber-reinforced plastic and carbon fiber-reinforced plastic disposed on said first side of said layer;
said at least one of glass fiber-reinforced plastic and carbon fiber-reinforced plastic forming said rear supporting layer and said front supporting layer being in a cured, non-flexible state.

13. A shielded satellite, consisting of:
a satellite; and
a multilayer armor plating disposed on said satellite, said multiplayer armor plating comprising:
a layer selected from the group consisting of single-piece ceramic layer, a multi-piece ceramic layer, a single piece metallic layer, and a multi-piece metallic layer, said layer having a first side facing a direction of attack and a second side;
a rear supporting layer formed of at least one of glass fiber-reinforced plastic and carbon fiber-reinforced plastic disposed next to said second side of said first layer; and
a front supporting layer formed of at least one of glass fiber-reinforced plastic and carbon fiber-reinforced plastic disposed on said first side of said layer;
said at least one of glass fiber-reinforced plastic and carbon fiber-reinforced plastic forming said rear supporting layer and said front supporting layer being in a cured, non-flexible state.

14. A process for producing a multilayer armor plating, which comprises the steps of:
providing a fiber-reinforced ceramic layer including at least one of carbon fibers or graphite fibers bound in a matrix formed predominantly of SiC, Si and C, the fiber-reinforced ceramic layer deviating from a flat plate and having a curvature and/or an angled-off section and/or varies in terms of a layer thickness, the fiber-reinforced ceramic layer being embedded in a composite;
applying a front supporting layer, formed of at least one material selected from the group consisting of glass fiber-reinforced plastic and carbon fiber-reinforced plastic, to a first surface of the composite and fiber-reinforced ceramic layer facing a load resulting from an attack;
applying a rear supporting layer, formed of at least one material selected from the group consisting of glass fiber-reinforced plastic and carbon fiber-reinforced plastic, to a second surface of the composite and fiber-reinforced ceramic layer facing away from the load resulting from the attack;
performing both of the applying steps for forming the front supporting layer and the rear supporting layer by the steps of:
impregnating at least one woven fabric selected from the group consisting of woven glass fiber fabrics and woven carbon fiber fabrics with a binder resin for forming fiber mats impregnated with binder;
curing the fiber mats to become non-flexible with at least one of heat and electromagnetic radiation during a curing period; and
pressing the fiber mats onto both the first and second surfaces of the fiber-reinforced ceramic layer at least during part of the curing period; and
applying a trapping layer, formed of a material selected from the group consisting of aluminum, aramid and dyneema, simultaneously during the pressing and curing steps, to a surface of the rear supporting layer which faces away from the load resulting from the attack, the trapping layer having no direct contact with said fiber-reinforced ceramic layer.

15. The process according to claim 14, which further comprises completely encasing the layer with the front supporting layer and the rear supporting layer.

16. (canceled)

17. The process according to claim 14, which further comprises in a case of performing the curing step by heat, setting a curing temperature in a range between 50° C. and 180° C.

18. The multilayer armor plating according to claim 9, wherein:
said rear supporting layer is formed from a cured prepeg that is flexible; and
said front supporting layer is formed from a cured prepeg that is flexible.
